(19) United States
(12) Patent Application Publication
(10) Pub. No.: US 2017/0249585 A1
(43) Pub. Date: Aug. 31, 2017

(54) SYSTEMS AND METHODS OF IDENTIFYING BUILDING ASSETS USED IN A WALK TEST

(71) Applicant: Honeywell International Inc., Morristown, NJ (US)

(72) Inventor: Robert John Teta, Louisville, KY (US)

(21) Appl. No.: 15/056,460

(22) Filed: Feb. 29, 2016

(51) Int. Cl. G06Q 10/08

(52) U.S. Cl. CPC G06Q 10/087

(57) ABSTRACT

Systems and methods of identifying building assets used in a walk test are provided. Some methods can include capturing an image of a device installed in a monitored region, identifying information related to the device from the image of the device, and storing the information related to the device for use when conducting a walk test in the monitored region.

### FIELD

The present invention relates generally to walk tests. More particularly, the present invention relates to systems and methods of identifying building assets used in a walk test.

### BACKGROUND

Walk tests are known in the art and can be executed in connection with a fire alarm system or any other ambient condition monitoring or security system installed in a building and as would be known and desired by one of ordinary skill in the art, including, but not limited to, gas detection systems and access control systems. Systems and methods to inspect building assets in connection with a walk test are also known in the art. For example, Honeywell International Inc. provides eVance™ Services that pulls data directly from control panels or other assets in a building to reduce the number of labor hours required to conduct a walk test.

However, in such systems and methods, the challenge remains of providing an identification of a type and description of a building asset. Some systems and methods are known for importing an electronic list of building equipment stored in a database device to identify and describe building assets. However, when such an electronic list is unavailable, technicians or other users must manually enter the identification and description of each building asset into a user interface device. This can be a time consuming and tedious process that requires that user to navigate through a series of configuration pages displayed on the device.

In view of the above, there is a continuing, ongoing need for improved systems and methods.

### BRIEF DESCRIPTION OF THE DRAWINGS

FIG. 1 is a block diagram of a system in accordance with disclosed embodiments.

### DETAILED DESCRIPTION

While this invention is susceptible of an embodiment in many different forms, there are shown in the drawings and will be described herein in detail specific embodiments thereof with the understanding that the present disclosure is to be considered as an exemplification of the principles of the invention. It is not intended to limit the invention to the specific illustrated embodiments.

Embodiments disclosed herein can include systems and methods of identifying building assets used in a walk test. For example, in some embodiments, a technician can provide user input to instruct a camera or other image capturing device of a user device to capture an image of a building asset, and systems and methods disclosed herein can use the captured image to identify the building device. It is to be understood that a user device as disclosed herein can include, but is not limited to, a tablet computer, cellular or mobile device, personal digital assistant, and the like. It is also to be understood that a building asset as disclosed herein can include, but is not limited to, a detector, extinguisher, exit sign, security system, or any other device or equipment installed in a building as would be known and desired by one of ordinary skill in the art.

Building asset identification information identified by systems and methods disclosed herein can be used to commission an ambient condition monitoring or security system installed in a building. For example, when commissioning or updating the ambient condition monitoring or security system, a technician can arrive at a device newly installed into the system and instruct a camera of a user device to capture an image of the device. Then, systems and methods disclosed herein can execute an image recognition or vision algorithm to identify the type of device in the captured image. In some embodiments, systems and methods disclosed herein can assign a respective function and class to the device or identify a manufacturer, model, serial number, manufacturer date, device address, or location of the device. Systems and methods disclosed herein can store information associated with the installed system in a database device and, in some embodiments, the database device can include fields for the identified device and the respective type, function, class, manufacturer, model, serial number, manufacturer date, device address, or location of the device as identified by systems and methods disclosed herein.

The user device can establish a wireless communication path with a remote cloud server device or with a control panel of the ambient condition monitoring or security system. In some embodiments, systems and methods disclosed herein can be implemented and executed on the user device to identify the type of device in the captured image and any other assigned or identified information related to the identified device. In these embodiments, systems and methods disclosed herein can transmit a signal indicative of the identified device and the assigned or identified information related to the identified device to the remote cloud server device or control panel for storing in a database device. Additionally or alternatively, in some embodiments, the user device can transmit a signal indicative of the captured image to the remote cloud server device or control panel, and systems and methods disclosed herein can be implemented and executed on the remote cloud server device or control panel to identify the type of device in the captured image and any other assigned or identified information related to the identified device. Such information can also be stored in a database device associated with the remote cloud server device or control panel.

In some embodiments, one or more of the user device, the cloud server device, and the control panel can include a user interface device for receiving user input to identify additional information to augment or supplement the device information assigned to or identified by the systems and methods disclosed herein. For example, when information cannot be captured from or identified in or by an image of a device captured by the user device, or when information is simply otherwise unavailable without receiving manual user input related thereto, a technician can provide user input to identify necessary, but missing information, such as, for example, a description of the device, an installation date of the device, or the like.

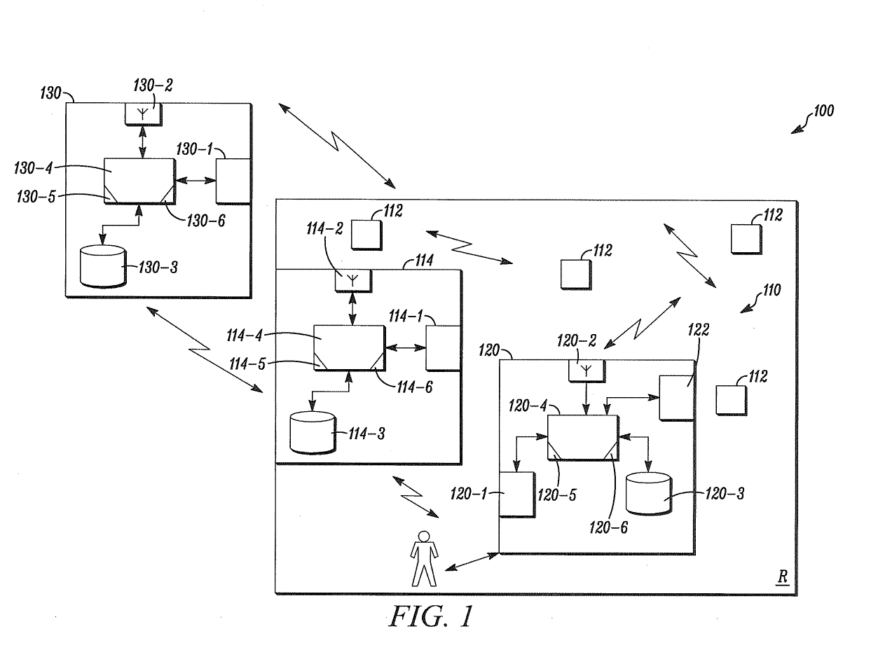

FIG. 1 is a block diagram of a system 100 in accordance with disclosed embodiments. As seen in FIG. 1, the system 100 can include an ambient condition monitoring or security system 110 installed in a region R, for example, a building. The system 110 can include a plurality of building assets or other devices 112 installed throughout the region R and a control panel 114.

A user U in the region R can conduct a walk test of the system 110, and specifically, of the system devices 112, using a user device 120, which can also be used to identify the devices 112 prior to or during the walk test. The user device 120 can establish one or more wireless communication paths with each of devices 112, with the control panel 114 of the system 110, and with a cloud server device 130, which can include a remote monitoring station or the like.

The user device 120 can include a camera or other image capturing device 122. Furthermore, each of the control panel 114, the user device 120, and the cloud server device 130 can include a user interface device 114-1, 120-1, 130-1, a transceiver 114-2, 120-2, 130-2, and a database device 114-3, 120-3, 130-3, each of which can be in communication with respective control circuitry 114-4, 120-4, 130-4, one or more programmable processors 114-5, 120-5, 130-5, and executable control software 114-6, 120-6, 130-6 as would be understood by one of ordinary skill in the art. Each of the executable control software 114-6, 120-6, 130-6 can be stored on a transitory or non-transitory computer readable medium, including, but not limited to, local computer memory, RAM, optical storage media, magnetic storage media, flash memory, and the like. In some embodiments, some or all of the control circuitry 114-4, 120-4, 130-4, the programmable processors 114-5, 120-5, 130-5, and the control software 114-6, 120-6, 130-6 can execute and control the methods described above and herein.

For example, when in the vicinity of a system device 112, a user can provide user input to the user interface device 120-1 or the camera 122 instructing the camera 122 to capture an image of the device 112. In some embodiments, the control circuitry 120-4, programmable processor 120-5, and control software 120-6 can execute an image recognition or vision algorithm on the captured image to identify the device 112 in the captured image, including the type, function, class, manufacturer, model, serial number, manufacturer date, address, or location of the device 112. In some embodiments, the user interface device 120-1 can receive user input indicative of additional information related to the device 112. Then, the control circuitry 120-4, programmable processor 120-5, and control software 120-6 can store the identified information in the database device 120-3 or transmit a signal, via the transceiver 120-2, to one or both of the control panel 114 and the cloud server device 130 indicative of the identified information for storage in one or both of the database devices 114-3, 130-3. Additionally or alternatively, in some embodiments, the control circuitry 120-4, programmable processor 120-5, and control software 120-6 can transmit a signal, via the transceiver 120-2, to one or both of the control panel 114 and the cloud server device 130, indicative of the captured image of the device 112, and one or more of the control circuitry 114-4, 130-4, programmable processor 114-5, 130-5, and control software 114-6, 130-6 can execute an image recognition or vision algorithm on the captured image to identify the device 112 in the captured image, including the type, function, class, manufacturer, model, serial number, manufacturer date, address, or location of the device 112. In some embodiments, one or more of the user interface devices 114-1, 130-1 can receive user input indicative of additional information related to the device 112. Then, the control circuitry 114-4, 130-4, programmable processor 114-5, 130-5, and control software 114-6, 130-6 can store the identified information in one or more of the database devices 114-3, 130-3.

Although a few embodiments have been described in detail above, other modifications are possible. For example, the logic flows described above do not require the particular order described, or sequential order, to achieve desirable results. Other steps may be provided, or steps may be eliminated, from the described flows, and other components may be added to, or removed from, the described systems. Other embodiments may be within the scope of the invention.

From the foregoing, it will be observed that numerous variations and modifications may be effected without departing from the spirit and scope of the invention. It is to be understood that no limitation with respect to the specific system or method described herein is intended or should be inferred. It is, of course, intended to cover all such modifications as fall within the spirit and scope of the invention.

1. A method comprising:
a camera of a user device capturing an image of a second device installed in a monitored region, wherein first user input received by the user device instructs the camera to capture the image of the second device;
the user device identifying initial information related to the second device from the image of the second device;
the user device initiating a request for additional information responsive to the user device failing to identify necessary information related to the second device from the image of the second device;
the user device receiving, responsive to the request for the additional information, second user input indicative of the additional information related to the second device, wherein the additional information includes the necessary information related to the second device; and
the user device transmitting the initial information and the additional information related to the second device to a control panel for storage of the initial information and the additional information related to the second device in a database of the control panel for use when conducting a walk test in the monitored region.

2-3. (canceled)

4. The method of claim 1 wherein the initial information and the additional information related to the second device include a type, function, class, manufacturer, model, serial number, manufacturer date, device address, or location of the second device.

5. The method of claim 1 wherein the user device identifying the initial information related to the second device incudes the user device executing an image recognition or vision algorithm.

6. The method of claim 1 further comprising storing the initial information and the additional information related to the second device in a local database device of the user device.

7. The method of claim 1 further comprising transmitting a signal indicative of the initial information and the additional information related to the second device to a cloud server device for storage therein.

8-17. (canceled)

18. A system comprising:
a camera of a user device;
a database device;
a programmable processor of the user device; and
executable control software stored on a non-transitory computer readable medium of the user device,
wherein the camera captures an image of a second device installed in a monitored region,
wherein first user input received by the user device instructs the camera to capture the image of the second device,
wherein the executable control software is executed on the programmable processor to identify initial information related to the second device from the image of the second device,
wherein the user device initiates a request for additional information responsive to the user device failing to identify necessary information related to the second device from the image of the second device,
wherein the user device receives, responsive to the request for the additional information, second user input indicative of the additional information related to the second device,
wherein the additional information includes the necessary information related to the second device,
wherein the programmable processor causes a transmission of the initial information and the additional information related to the second device to the database device, and
wherein the database device stores the initial information and the additional information related to the second device for use when conducting a walk test in the monitored region.

19. The system of claim 18 further comprising:
a transceiver of the user device,
wherein the transceiver transmits the initial information and the additional information related to the second device to the database device for remote storage thereof.

20. (canceled)
